(19) United States
(12) Patent Application Publication
(10) Pub. No.: US 2014/0218270 A1
(43) Pub. Date: Aug. 7, 2014

(54) DISPLAY DEVICE, DRIVING METHOD OF DISPLAY DEVICE, AND ELECTRONIC APPARATUS

(71) Applicant: Sony Corporation, Tokyo (JP)

(72) Inventor: Naobumi Toyomura, Kanagawa (JP)

(73) Assignee: SONY CORPORATION, Tokyo (JP)

(21) Appl. No.: 14/161,970

(22) Filed: Jan. 23, 2014

(30) Foreign Application Priority Data
Feb. 4, 2013 (JP) 2013-019291

(51) Int. Cl. G09G 3/30

(52) U.S. Cl. CPC G09G 3/30
USPC 345/76

(57) ABSTRACT

The driving method of the display device having a driving transistor in at least one of the pixels, includes providing a display frame period consisting of a first period and a second period, a duration of the second period being longer than the first period and being set as the first period subtracted from the display frame period. The driving method also includes performing a threshold correction for the driving transistor during the first period and writing a signal voltage for the pixel during the second period.

### CROSS REFERENCE TO RELATED APPLICATIONS

This application claims the benefit of Japanese Priority Patent Application JP 2013-019291 filed Feb. 4, 2013, the entire contents of which are incorporated herein by reference.

### BACKGROUND

The present disclosure relates to a display device, a driving method of the display device, and an electronic apparatus, more particularly, relates to a planar (flat panel) display device that is formed by two-dimensionally disposing pixels (pixel circuit) including a light-emitting unit in a matrix manner, a driving method of the display device, and an electronic apparatus which has the display device.

As one of the planar display device, there is a display device which uses a current-driven electro-optical element in which luminescence brightness changes according to a value of a current which flows through a light-emitting unit (light-emitting element), as the light-emitting unit. As a current-driven electro-optical element, for example, an organic EL element which is obtained by using a phenomenon emitting light due to electro luminescence (EL) of an organic material when an electric field is applied to an organic thin film is known.

In the planar display device such as an organic EL display device, there is a case where a transistor characteristic which drives an electro-optical element as the light-emitting unit, specifically, the transistor characteristic such as a threshold voltage varies for each pixel by changes in process and the like. Variations in the transistor characteristic affect the luminance brightness.

More specifically, even if a video signal of the same level (signal voltage) is written to each pixel, display unevenness occurs because the luminance brightness varies between pixels, and uniformity of a display screen is impaired. For this reason, a technology for correcting the display unevenness due to variation characteristics of elements configuring the pixel circuit, specifically, a technology for performing a correction operation of the threshold voltage and the like is proposed (for example, refer to Japanese Unexamined Patent Application Publication No. 2008-083272).

### SUMMARY

In the related art disclosed in Japanese Unexamined Patent Application Publication No. 2008-083272, since (1) threshold correction and (2) in signal writing and a mobility correction which is performed in the same period as the signal writing are to be performed during one horizontal period, a reference voltage which is used for the threshold correction with respect to signal lines and a signal voltage of a video signal are rewritten for each horizontal period. For this reason, the number of charging and discharging in each of the signal lines is increased and power consumption of a signal output unit (so-called, signal driver) which supplies the reference voltage and the signal voltage to the signal lines is decreased. In other words, there is a problem in that the power consumption of the signal output unit, and furthermore, of the power consumption of the display device are increased according to the correction operation of display unevenness due to variation characteristics of elements configuring the pixel circuit.

It is desirable to provide a display device in which power consumption according to correction operation of display unevenness due to variation characteristics of elements configuring a pixel circuit can be decreased, a driving method of the display device, and an electronic apparatus which has the display device.

Specifically, the display device has a plurality of pixel circuits, a scan line, a signal line, at least one of the plurality of pixel circuits including a driving transistor. Further, a display frame period has a first period and a second period where a length of the first period being shorter than a length of the second period and being set as the first period subtracted from the display frame period. Additionally, a threshold correction for the driving transistor is performed during the first period, and a signal voltage writing to one of the plurality of pixel circuits via the signal line is performed during the second period.

The driving method of the display device including a pixel having a driving transistor, comprises providing a display frame period consisting of a first period and a second period, a duration of the second period being longer than the first period and being set as the first period subtracted from the display frame period; performing a threshold correction for the driving transistor during the first period; and writing a signal voltage for the pixel during the second period.

The electronic apparatus has the display device as described above.

According to the embodiments of the present disclosure, since it is possible to significantly reduce the number of charging and discharging in each signal line, it is possible to decrease consumption power accompanied by correction operation of display unevenness due to variation characteristics of elements configuring a pixel circuit. Moreover, since it is possible to more reliably perform threshold correction, signal writing, and mobility correction by sufficiently ensuring operation time of the threshold correction per operation and ensuring a margin of the operation time of the mobility correction, it is possible to obtain a display screen with high uniformity.

### BRIEF DESCRIPTION OF THE DRAWINGS

FIG. 1 is a system configuration diagram illustrating a basic configuration of an active matrix-type display device to which the present disclosure is applied;

FIG. 2 is a circuit diagram illustrating an example of a specific circuit configuration of a pixel (pixel circuit);

FIG. 3 is a timing waveform diagram for describing a driving method according to the related art of an active matrix-type organic EL display device to which the present disclosure is applied;

FIG. 4A is an operation explanatory diagram of a light-emission period of a previous display frame;

FIG. 4B is an operation explanatory diagram of a light-extinction period;

FIG. 5A is an operation explanatory diagram of a threshold correction preparation period;

FIG. 5B is an operation explanatory diagram of a threshold correction period;

FIG. 6A is an operation explanatory diagram of a signal writing and mobility correction period;

FIG. 6B is an operation explanatory diagram of a light-emission period of a current display frame;

FIG. 7 is a timing waveform diagram with regard to a driving method according to a reference example;

FIG. 8 is a conceptual diagram with regard to the threshold correction, the signal writing, and the mobility correction in a case of the driving method according to the reference example;

FIG. 9A is a timing waveform diagram with regard to the driving method according to an example; and

FIG. 9B is a timing waveform diagram with regard to the driving method according to an example; and

FIG. 10 is a conceptual diagram with regard to the threshold correction, the signal writing, and the mobility correction in a case of the driving method according to the example.

### DETAILED DESCRIPTION OF EMBODIMENTS

Hereinafter, a mode for carrying out a technology of the present disclosure (hereinafter, referred to as “embodiment”) will be described in detail with reference to the drawings. The present disclosure is not limited to the embodiment and various numerical values in the embodiment are exemplary. In the following description, the same reference numerals are used in the same elements or the elements which have the same functions, and redundant descriptions will be omitted. Meanwhile, the description thereof will be given in following order.

1. General Description of Display Device, Driving Method of Display Device, and Electronic Apparatus According to an Embodiment of the Present Disclosure

2. Active Matrix-Type Display Device to Which the Present Disclosure Is Applied.

2-1. System Configuration

2-2. Pixel Circuit

2-3. Driving Method According to the Related Art

3. Description With Respect to Embodiment

3-1. Reference Example

3-2. Example

4. Modified Example

5. Electronic Apparatus

6. Configuration of the Present Disclosure

### 1. General Description of Display Device, Driving Method of Display Device, and Electronic Apparatus According to an Embodiment of the Present Disclosure

A display device according to an embodiment of the present disclosure is a planar (flat panel) display device which is formed by disposing a pixel circuit (pixel) which has a light-emitting unit, a sampling transistor, a driving transistor, and a holding capacitor.

Here, the sampling transistor writes a signal voltage of a video signal in a pixel by sampling the signal voltage. A holding capacitor holds the signal voltage which is sampled (written) by the sampling transistor. A driving transistor drives the light-emitting unit according to the signal voltage which is held by the holding capacitor.

As a planar display device, it is possible to exemplify an organic EL display device, a liquid crystal display device, and a plasma display device, and the like. Among these display devices, the organic EL display device uses the organic EL element using a phenomenon in which light is emitted when an electric filed is applied to an organic thin film using an electroluminescence of an organic material as a light-emitting element (electro-optical element) of the pixel.

The organic EL display device in which the organic EL element is used as the light-emitting unit of the pixel has following features. That is, since the organic EL element can be driven at an applied voltage of 10 V or less, the organic EL display device has low power consumption. Since the organic EL element is a self light-emitting element, it is easy to make the organic EL display device light and thin compared to a liquid crystal display device, which is the same planar display device, because image visibility the organic EL display device is high and furthermore an illumination member such as backlight and the like is not necessary in the organic EL display device. Furthermore, since response speed of the organic EL element is so fast to be approximately several μsec, a residual image in moving picture display does not occur in the organic EL display device.

The organic EL element is the self light-emitting element. In addition, the organic EL element is a current-driven electro-optical element. As the current-driven electro-optical element, it is possible to exemplify an inorganic EL element, a LED element, and a semi-conductor laser element, and the like in addition to the organic EL element.

In the planar display device of the above-described configuration, one display frame period is divided into two and a second half divided period which is set to be longer than the first half divided period when the pixel circuit is driven. Then, threshold correction of the driving transistor is performed in the first half divided period, and writing (hereinafter, there may be a case of being referred to as “signal writing”) of the signal voltage is performed in the second half divided period which is set to be longer than the first half divided period under the driving by the drive unit which drives the pixel circuit in the display device.

It is possible that the planar display device such as the organic EL display device or the like uses a display unit including various electronic apparatuses as the display unit (display device) thereof. As the various electronic apparatuses in addition to television system, it is possible to exemplify a portable information device such as a digital camera, a video camera, a game console, a notebook personal computer, and an e-book, and the like, and a mobile communication device such as personal digital assistant (PDA) or a mobile phone or the like.

It is possible that the display device, the driving method of the display device, and the electronic apparatus including the above-described preferred configuration according to the embodiment of the present disclosure are configured to perform mobility correction of a driving transistor in the first half divided period, in other words, in the same period as the signal writing. In addition, it is possible to configure to be connected between a gate electrode of the driving transistor and one of source and drain electrodes with regard to the holding capacitor. Furthermore, it is possible that the display device, the driving method, and the electronic apparatus are configured to sample a reference voltage which is supplied to a signal line at timing different from the signal voltage of the video signal and is used to the threshold correction to be described later with regard to the sampling transistor. In other words, it is possible that the display device, the driving method, and the electronic apparatus are configured to perform the sampling of the reference voltage in the first half divided period in which one display frame period is divided into two and to perform the sampling of the signal voltage in the second half divided period which is set to be longer than the first half divided period with regard to the sampling transistor.

In addition, it is possible that the display device, the driving method of the display device, and the electronic apparatus including the above-described preferred configuration according to the embodiment of the present disclosure are configured to perform the threshold correction which corrects a threshold voltage of the driving transistor with regard to the drive unit. It is possible that the threshold correction is performed by changing a potential of one of source and drain electrodes of the driving transistor to be a potential obtained by subtracting the threshold voltage of the driving transistor from the initialization potential based on an initialization potential of the gate potential of the driving transistor. It is possible that the reference voltage which supplied to the signal line in the first half divided period is sequentially used to determine the initialization potential of the gate potential of the driving transistor.

In addition, it is possible that the display device, the driving method of the display device, and the electronic apparatus including the above-described preferred configuration according to the embodiment of the present disclosure are configured to perform the mobility correction which corrects mobility of the driving transistor with regard to the drive unit. It is possible that the mobility correction is performed by applying negative feedback to the holding capacitor in a feedback quantity capacitor which corresponds to the current flowing through the driving transistor in the writing period during which the signal voltage of the video signal is written by the sampling transistor. The signal voltage of the video signal is supplied to the signal line in the first half divided period.

### 2. Active Matrix-Type Display Device to which the Present Disclosure is Applied

### 2-1. System Configuration

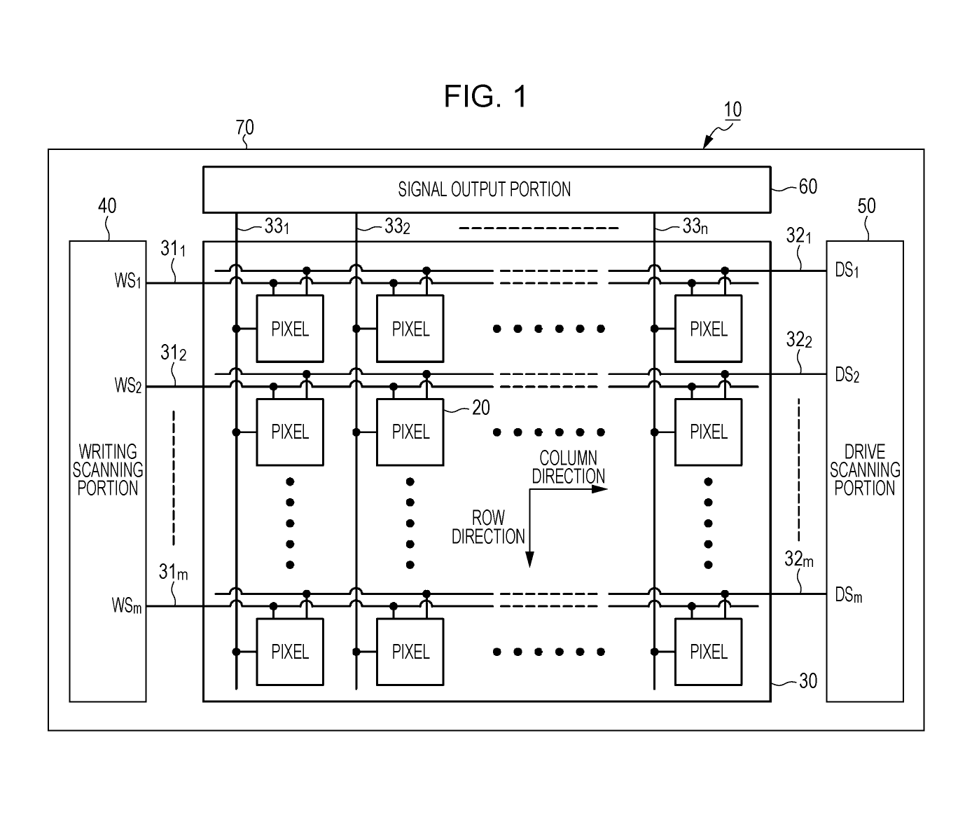

FIG. 1 is a system configuration diagram illustrating a basic configuration of an active matrix-type display device to which the present disclosure is applied.

The Active matrix-type display device is an active element which is provided with the current flowing through an electro-optical element in the pixel same as the electro-optical element, for example, is the display device which controls the current by an insulated-gate field-effect transistor. It is possible to typically use a thin film transistor (TFT) as the insulated-gate field-effect transistor.

Here, as an example, description will be given by exemplifying a case of the active matrix-type organic EL display device in which, for example, the organic EL element, which is a current-driven electro-optical element in which luminance brightness is changed according to the current value flowing through the device is used as the light-emitting element of the pixel (pixel circuit). Hereinafter, there may be a case where the “pixel circuit” is simply referred to as the “pixel”.

As illustrated in FIG. 1, the organic EL display device 10, which is an assumption of the present disclosure, is configured to have a pixel array unit 30 which is formed by two-dimensionally disposing a plurality of pixels 20 including the organic EL element in a row-column manner (matrix manner) and a driving circuit unit (drive unit) which is disposed on the periphery of the pixel array unit 30. The driving circuit unit, for example, is formed by a writing scanning unit 40 which is mounted on a display panel 70 which is the same as a pixel array unit 30, a drive scanning unit 50, and a signal output unit 60, and the like. The driving circuit unit drives each pixel 20 of the pixel array unit 30. Moreover, it is possible to adopt a configuration which is provided with some or all of the writing scanning unit 40, drive scanning unit 50, and the signal output unit 60 outside the display panel 70.

Here, in a case where the organic EL display device 10 is for color display, one pixel (unit pixel/pixel), which is a unit for forming a color image, is configured to have a plurality of sub-pixels. At this time, each of the sub-pixels corresponds to a pixel 20 of FIG. 1. More specifically, in the display device for the color display, one pixel, for example, is configured to have three sub-pixels; a sub pixel which emits red (R) light, a sub-pixel which emits green (G) light, and a sub-pixel which emits blue (B) light.

However, as one pixel, it is possible that one pixel is not limited to combination of the sub-pixels of three primary colors of RGB but is configured by further adding one color or a plurality of the sub-pixels to the three primary colors. More specifically, for example, it is possible that a sub-pixel emitting white (W) light for brightness enhancement is configured to have one pixel or one pixel is configured by adding at least one sub-pixel which emits complementary color light in order to expand the color reproduction range.

Scanning lines 31 (31₁ to 31ₘ) and power supply lines 32 (32₁ to 32ₘ) are wired along the row direction (array direction/horizontal direction of pixel of pixel row) for each pixel row with respect to the array of a pixel 20 of m rows and n columns in the pixel array unit 30. Furthermore, signal lines 33 (33₁ to 33ₙ) are wired along the column direction (array direction/vertical direction of pixel of pixel column) for each pixel column with respect to the array of the pixel 20 of m rows and n columns.

The scanning lines 31₁ to 31ₘ are respectively connected to an output end of the row which corresponds to the writing scanning unit 40. The power supply lines 32₁ to 32ₘ are respectively connected to the output end of the row which corresponds to the drive scanning unit 50. The signal lines 33₁ to 33ₙ are respectively connected to the output end of the column which corresponds to the signal output unit 60.

The writing scanning unit 40 is configured to have a shift register circuit and the like. The writing scanning unit 40 sequentially scans in units of row, that is, performs line sequential scanning the each pixel 20 of the pixel array unit 30 by sequentially supplying write-scan signals WS (WS₁ to WSₘ) to the scanning lines 31 (31₁ to 31ₘ) at the time of writing of signal voltage of the video signal to the each pixel 20 of the pixel array unit 30.

The drive scanning unit 50 is configured to have the shift register circuit and the like in the same manner as the writing scanning unit 40. The drive scanning unit 50 is synchronized with the line sequential scanning by the writing scanning unit 40 and supplies power potentials DS (DS₁ to DSₘ) that can be switched by the first power potential V_{cc}_{_{—}}_{H} and the second power potential V_{cc}_{_{—}}_{L} which is lower than the first power potential V_{cc}_{_{—}}_{H} to the power supply lines 32 (32₁ to 32ₘ). As will be described later, control of light-emission/non-light-emission (light extinction) of the pixel 20 is performed by the switching of power potential DS of V_{cc}_{_{—}}_{H}/V_{cc}_{_{—}}_{L} by the drive scanning unit 50.

The signal output unit 60 selectively outputs a signal voltage V_{sig} (hereinafter, there may be a case of being referred to as “signal voltage”) of the video signal and a reference voltage V_{ofs} which correspond to luminance information supplied from a signal supply source (not illustrated). Here, the reference voltage V_{ofs} is a voltage (for example, voltage corresponding to black level of video signal) which serves as a reference of the signal voltage V_{sig} of the video signal and is used in a threshold correction treatment to be described later.

The signal voltage V_{sig}/reference voltage V_{ofs} which are output from the signal output unit 60 are written with respect to the each pixel 20 of pixel array unit 30 via the signal lines 33 (33₁ to 33ₙ) in units of pixel row selected by scanning by the writing scanning unit 40. That is, the signal output unit 60 adopts driving form of the line sequential writing which writes the signal voltage V_{sig} in units of row (line).

### 2-2. Pixel Circuit

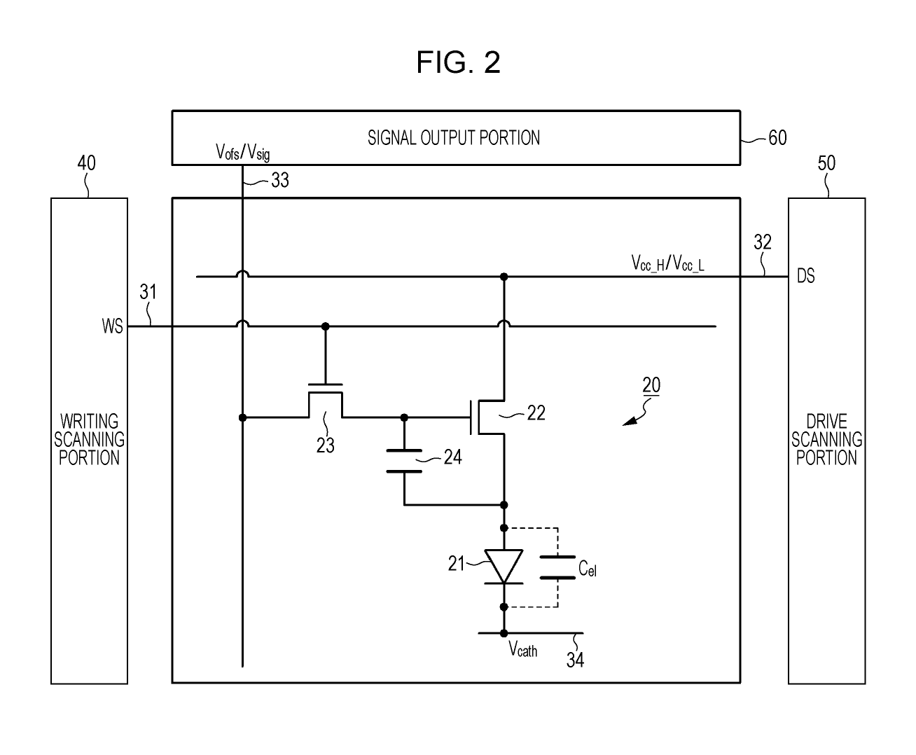

FIG. 2 is a circuit diagram illustrating an example of a specific circuit configuration of the pixel (pixel circuit) 20. The light-emitting unit of the pixel 20 is configured to have the organic EL element 21, which is the current-driven electro-optical element in which the luminance brightness is changed according to the current value flowing through the device.

As illustrated in FIG. 2, the pixel 20 is configured to have the organic EL element 21 and a driving circuit which drives the organic EL element 21 by flowing the current through the organic EL element 21. A cathode electrode of the organic EL element 21 is connected to a common power supply line 34 which is connected in common to all the pixels 20. FIG. 2 also illustrates an equivalent capacitor Cₑₗ of the organic EL element 21.

The driving circuit which drives the organic EL element 21 is configured to have a driving transistor 22, sampling transistor 23, and a holding capacitor 24. It is possible to use an N-channel type TFT as the driving transistor 22 and the sampling transistor 23. However, a combination of conductivity type of the driving transistor 22 and the sampling transistor 23 is merely an example and is not limited to this combination.

One electrode (source and drain electrodes) of the driving transistor 22 is connected to an anode electrode of the organic EL element 21 and the other electrode (source and drain electrodes) is connected to the power supply lines 32 (32₁ to 32ₘ).

One electrode (source and drain electrodes) of the sampling transistor 23 is connected to the signal line 33 (33₁ to 33ₙ) and the other electrode (source and drain electrodes) is connected to a gate electrode of the driving transistor 22. In addition, the gate electrode of the sampling transistor 23 is connected to the scanning lines 31 (31₁ to 31ₘ).

One electrode is a metal wire which is electrically connected to one of the source and drain regions and the other electrode is a metal wire which is electrically connected to the other source and drain regions in the driving transistor 22 and the sampling transistor 23. In addition, if one electrode becomes the source drain electrode, the one electrode becomes the drain electrode, and if the other electrode becomes the drain electrode, one electrode becomes the source drain by the potential relation between one electrode and the other electrode.

One electrode of the holding capacitor 24 is electrically connected to the gate electrode of the driving transistor 22 and the other electrode of the holding capacitor is electrically connected to the other electrode of the driving transistor 22 and the anode electrode of the organic EL element 21.

The sampling transistor 23 becomes conductive in the above-described pixel 20 in response to a high-active write-scan signal WS which is applied to the gate electrode through a scanning line 31 from a writing scanning unit 40. As a result, the sampling transistor 23 write the signal voltage V_{sig} or the reference voltage V_{ofs} in the pixel 20 by sampling the signal voltage V_{sig} of the video signal which is supplied from the signal output unit 60 through the signal line 33 at a timing different and corresponds to the luminance information. The signal voltage V_{sig} or the reference voltage V_{ofs}, which are written by the sampling transistor 23, is applied to the gate electrode of the driving transistor 22 and is held by the holding capacitor 24.

One electrode of the driving transistor 22 becomes the drain electrode and the other electrode of the driving transistor 22 becomes the source electrode and operates in a saturation region when the power potential DS of the power supply lines 32 (32₁ to 32ₘ) are in the first power potential V_{cc}_{_{—}}_{H}. As a result, the driving transistor 22 is supplied with the current from the power supply line 32 and drives the organic EL element 21 to emit light by the current driving. More specifically, the driving transistor 22 supplies a driving current of the current value which corresponds to the voltage value of the signal voltage V_{sig} which is held by the holding capacitor 24 by operation in the saturation region to the organic EL element 21 and emits the light by current-driving the organic EL element 21.

Furthermore, one electrode of the driving transistor 22 becomes the source electrode and the other electrode of the driving transistor becomes the drain electrode and operates as a switching transistor when the power potential DS is switched from the first power potential V_{cc}_{_{—}}_{H} to the second power potential V_{cc}_{_{—}}_{L}. As a result, the driving transistor 22 stops the supply of the drive current to the organic EL element 21 and places the organic EL element 21 in a non-light-emission state. That is, the driving transistor 22 also has a function as the transistor which controls light-emission/non-light-emission of the organic EL element 21 under the switching of the power potential DS (V_{cc}_{_{—}}_{H}/V_{cc}_{_{—}}_{L}).

A period (non-light-emission period) in which the organic EL element 21 becomes the non-light-emission state is provided by the switching operation of the driving transistor 22 and it is possible that the ratio (duty) of light-emission period and non-light-emission period of the organic EL element 21 is controlled. Since a residual image blur accompanied by the light emission of the pixel over the one display frame period can be decreased by the duty control, in particular, it is possible that the image quality of the video is made to be more excellent.

Among the first and the second power potentials V_{cc}_{_{—}}_{H} and V_{cc}_{_{—}}_{L} which is selectively supplied through the power supply line 32 from the drive scanning unit 50, the first power potential V_{cc}_{_{—}}_{H} is the power potential for supplying the driving current which drives the organic EL element 21 to emit the light to the driving transistor 22. In addition, the second power potential _{Vcc}_{_{—}}_{L} is the power potential for applying a reverse bias to the organic EL element 21. The second power potential V_{cc}_{_{—}}_{L} is set to a potential which is lower than the reference voltage V_{ofs}, a potential which is also lower than the V_{ofs}−Vₜₕ, preferably, a potential which is sufficiently lower than the V_{ofs}−Vₜₕ, for example, when the threshold voltage of the driving transistor 22 is set to Vₜₕ.

### 2-3. Driving Method According to the Related Art

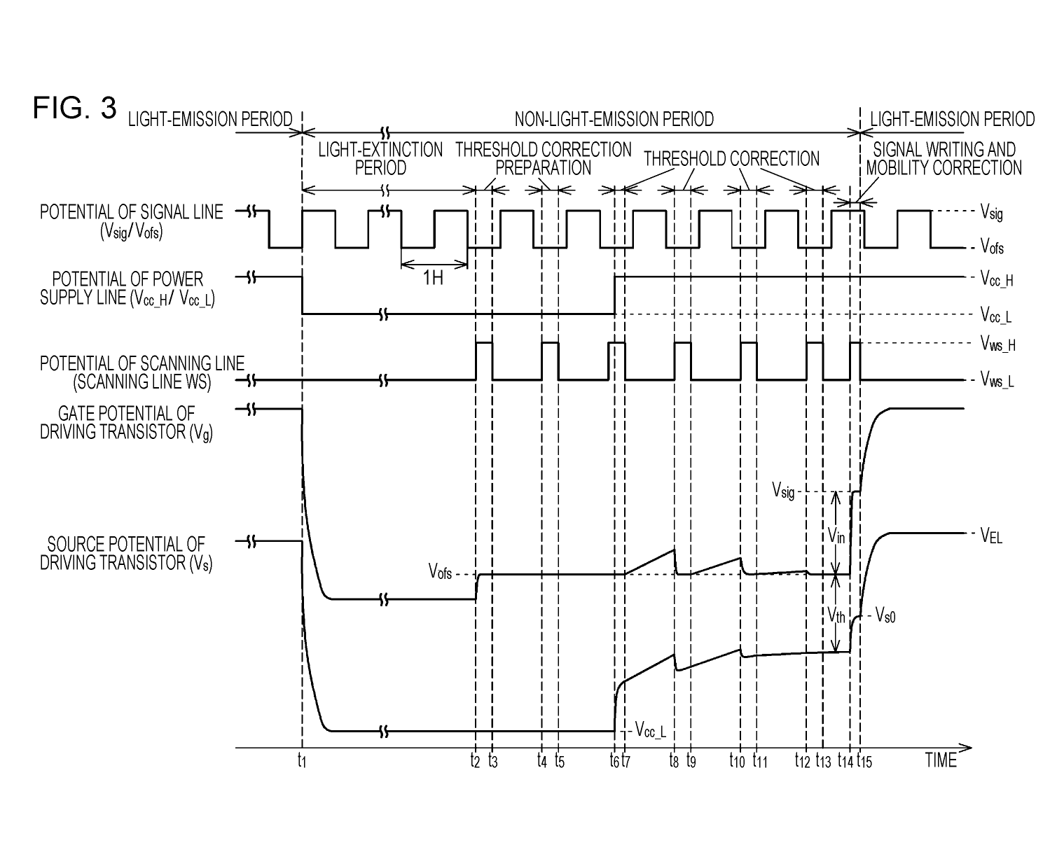

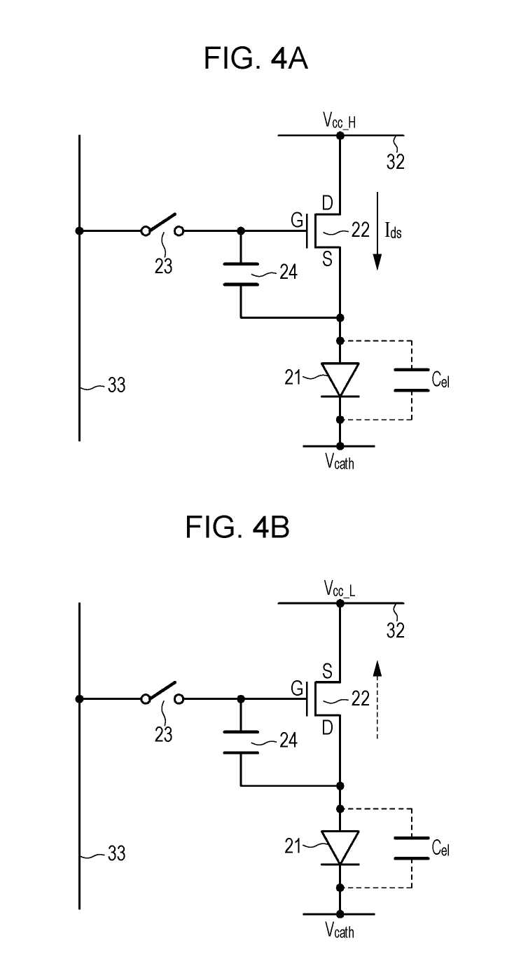

Subsequently, description will be given with regard to circuit operation of the driving method according to the related art of the organic EL display device 10 of the above-described configuration based on the timing waveform diagram of FIG. 3 with reference to the operation explanatory diagrams of FIGS. 4 to 6. Moreover, the sampling transistor 23 is illustrated in a symbol of the switch in order to simplify the drawing in the operation explanatory diagrams of FIGS. 4 to 6.

The change of each of the potential (write-scan signal) WS of the scanning line 31, the potential (power potential) DS of the power supply line 32, the potential (V_{sig}/V_{ofs}) of the signal line 33, the gate potential V_{g} and the source potential Vₛ of the driving transistor 22 is illustrated in the timing waveform diagram of FIG. 3. Here, the switching cycle of the potential of the signal line 33, that is, the switching cycle of the signal voltage V_{sig} of the video signal and the reference voltage V_{ofs} is one horizontal period (1H).

Moreover, since the sampling transistor 23 is the N-channel type, the state of the high potential of the write-scan signal WS becomes an active state and the state of the low potential becomes a non-active state. Then, the sampling transistor 23 becomes conductive in the active (high active) state of the write-scan signal WS and becomes non-conductive in the non-active state.

Light-Emission Period of Previous Display Frame

Before time t₁ is the light-emission period of the organic EL element 21 in the previous display frame in the timing waveform diagram of FIG. 3. The potential DS of the power supply line 32 is in the first power potential V_{cc}_{_{—}}_{H} (hereinafter, referred to as “high potential”), in addition, the sampling transistor 23 becomes non-conductive in the light-emission period of the previous display frame.

At this time, the driving transistor 22 is set to operate in the saturation region. As a result, as illustrated in FIG. 4, a driving current (current between drain and source) I_{ds} which corresponds to the potential V_{gs} between the gate and the source of the driving transistor 22 is supplied to the organic EL element 21 through the driving transistor 22 from the power supply line 32. Accordingly, the organic EL element 21 emits light at a luminance which corresponds to the current value of the driving current I_{ds}.

The driving current (current between drain and source of driving transistor 22) I_{ds} which is supplied to the organic EL element 21 is given by the following Equation (1).

I_{ds}=(½)·μ(W/L)Cₒₓ(V_{gs}−Vₜₕ)² (1)

Here, W is a channel width do of the driving transistor 22, L is a channel length of the driving transistor 22, and Cₒₓ is a gate capacitor per unit area of the driving transistor 22.

Light-Extinction Period

When the time t₁ comes, the non-light-emission period of the new display frame (current display frame) of line sequential scanning is entered. Then, at the time t₁, as illustrated in FIG. 4B, the potential DS of the power supply line 32 is switched from the high potential V_{cc}_{_{—}}_{H} to the second power potential (hereinafter, referred to as “low potential”) V_{cc}_{_{—}}_{L}.

Here, the threshold voltage of the organic EL element 21 is set to Vₜₕ_{_{—}}_{EL} and the potential (gate potential) of the common power supply line 34 is set to V_{cath}. At this time, if the low potential V_{cc}_{_{—}}_{L} is set to V_{cc}_{_{—}}_{L}<Vₜₕ_{_{—}}_{EL}+V_{cath}, the light of the organic EL element 21 extincts in order to become a reverse biased state. In addition, the source and drain regions of the power supply line 32 side of the driving transistor 22 become a source region, the source and drain regions of the organic EL element 21 side becomes a drain region. At this time, the anode electrode of the organic EL element 21 is charged to the low potential V_{cc}_{_{—}}_{L}.

Threshold Correction Preparation Period

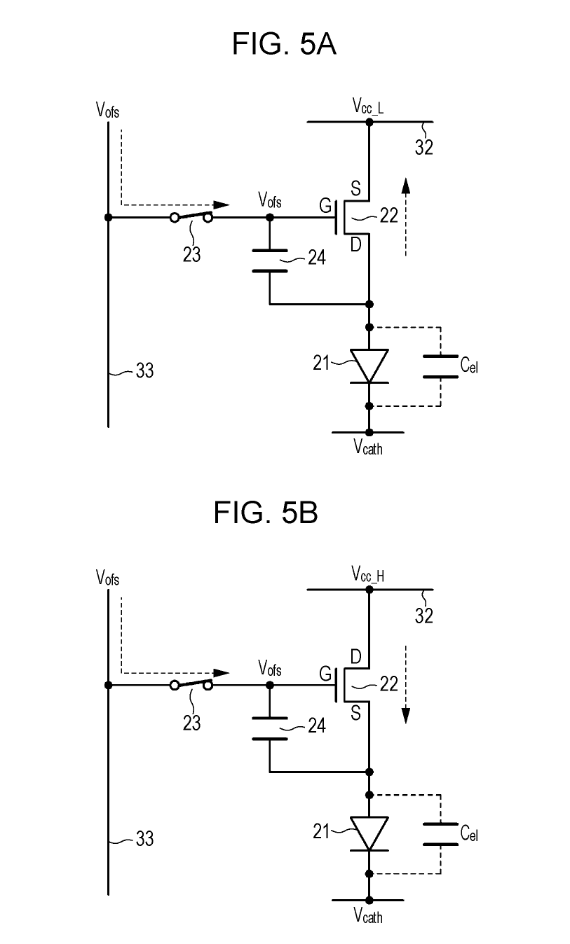

Next, when the reference voltage V_{ofs} is supplied to the signal line 33, if the potential WS of the scanning line 31 is shifted to the high potential V_{ws}_{_{—}}_{H} from the low potential V_{ws}_{_{—}}_{L} at time t₂, as illustrated in FIG. 5A, the sampling transistor 23 becomes conductive and samples the reference voltage V_{ofs}. As a result, the gate potential V_{g} of the driving transistor 22 becomes the reference voltage V_{ofs}. In addition, the source potential Vₛ of the driving transistor 22 is in the potential which is sufficiently lower than the reference voltage V_{ofs}, that is the low potential V_{cc}_{_{—}}_{L}.

At this time, the voltage V_{gs} between the gate and the source of the driving transistor 22 becomes the V_{ofs}−V_{cc}_{_{—}}_{L}. Here, if the V_{ofs}−V_{cc}_{_{—}}_{L} is not lager than the threshold voltage Vₜₕ of the driving transistor 22, since it is difficult to perform the threshold correction treatment (threshold correction operation) to be described later, it is necessary to set the potential relation of V_{ofs}−V_{cc}_{_{—}}_{L}>Vₜₕ.

In this manner, the gate potential V_{g} of the driving transistor 22 is set to the reference voltage V_{ofs}, in addition, the treatment of setting (determining) and initializing the source potential Vₛ to the low potential V_{cc}_{_{—}}_{L} is a treatment of preparation (threshold correction perforation) before the performance of the threshold correction treatment to be described later. Accordingly, the reference voltage V_{ofs} and the low potential V_{cc}_{_{—}}_{L} become the gate electrode V_{g} of the driving transistor 22 and each initialization potential of the source potential Vₛ.

In this manner, the operation of a first threshold correction preparation is performed in the periods of time t₂ to time t₃ in which the potential WS of the scanning line 31 becomes the high potential V_{ws}_{_{—}}_{H}. Then, the operation of a second threshold correction preparation is performed in the same manner as the first threshold correction preparation in the periods of time t₄ to time t₅ in the following one horizontal period.

Threshold Correction Period

Subsequently, the potential of the signal line 33 is in the reference voltage V_{ofs}, the potential DS of the power supply line 32 is switched from the low potential V_{cc}_{_{—}}_{L} to the high potential V_{cc}_{_{—}}_{H} at time t₆ in the period in which the potential WS of the scanning line 31 becomes the high potential V_{ws}_{_{—}}_{H}. As a result, the source and drain regions of the power supply line 32 side of the driving transistor 22 becomes the drain region, and the source and drain regions of the organic EL element 21 side becomes the source region, and as illustrated in FIG. 5B, the current flows through the driving transistor 22.

The equivalent circuit of the organic EL element 21 is represented by a diode and an equivalent capacitor Cₑₗ. Accordingly, the source potential Vₛ of the driving transistor 22 is not limited to being Vₛ≦Vₜₕ_{_{—}}_{EL}+V_{cath} (leakage current of organic EL element 21 is sufficiently smaller than the current flowing through driving transistor 22), the current flowing through the driving transistor 22 is used in order to charge the holding capacitor 24 and the equivalent capacitor Cₑₗ of the organic EL element 21. At this time, the source potential Vₛ of the driving transistor 22 is increased over time as illustrated in FIG. 3.

The sampling transistor 23 becomes non-conductive by shifting the potential WS of the scanning line 31 from the high potential V_{ws}_{_{—}}_{H} to the low potential V_{cc}_{_{—}}_{L} at time t₇ when the predetermined time elapses. At this time, the current flows through the driving transistor 22, as illustrated in the timing waveform diagram of FIG. 3, both the gate potential V_{g} and the source potential Vₛ of the driving transistor 22 are increased in order that the voltage V_{gs} between the gate and the source of the driving transistor 22 is larger than the threshold voltage Vₜₕ.

In this manner, the treatment (operation) which changes the source potential Vₛ to be the potential in which the threshold voltage Vₜₕ of the driving transistor 22 is decreased from the initialization potential V_{ofs} based on the initialization potential V_{ofs} of the gate potential V_{g} of the driving transistor 22 is the threshold correction treatment (operation). At this time, as long as Vₛ≦Vₜₕ_{_{—}}_{EL}+V_{cath}, light emission does not occur because the reverse bias is applied to the organic EL element 21.

The second threshold correction treatment is started by shifting the potential WS of the scanning line 31 to the high potential V_{ws}_{_{—}}_{H} again at time t₈ and the sampling transistor 23 becoming conductive in the following one horizontal period in which the potential of the signal line 33 becomes the reference voltage V_{ofs} again. The second threshold correction treatment is performed until time t₉ in which the potential WS of the scanning line 31 is shifted to the low potential V_{ws}_{_{—}}_{L}.

Finally, the voltage V_{gs} between the gate and the source of the driving transistor 22 converges to the threshold voltage Vₜₕ of the driving transistor 22 by repeating the above operation. The voltage which corresponds to the threshold voltage Vₜₕ is held by the holding capacitor 24. At this time, Vₛ=V_{ofs}−Vₜₕ≦Vₜₕ_{_{—}}_{EL}+V_{cath}.

In this example, a driving method which divides the threshold correction treatment and performs the threshold correction treatment more than once, so-called, performs divided threshold correction is adopted. However, the driving method is not limited to the adoption of the driving method of the divided threshold correction, and of course, the driving method which performs the threshold correction treatment only once may be adopted. Here, the “divided threshold correction” is a driving method which divides the threshold correction treatment over a plurality of the horizontal periods prior to the one horizontal period and performs the threshold correction treatment more than once in addition to the one horizontal period which is performed with signal writing and mobility correction treatment to be described later.

According to the driving method of the divided threshold correction, even if time which is allocated as one horizontal period by the number of pixels accompanied by high definition is decreased, it is possible to ensure sufficient time over the plurality of horizontal periods as the threshold correction period. Accordingly, even if the time allocated as the one horizontal time is decreased, since it is possible to ensure the sufficient time as the threshold correction period, it is possible to reliably perform the threshold correction treatment.

In this example, the threshold correction treatment is performed two more times, four times in total in addition to the above-described the first and the second threshold correction treatment under the driving method of divided threshold correction. That is, a third and a fourth threshold correction treatments are sequentially performed in synchronization with the timing in which the potential WS of the scanning line 31 is shifted from the low potential V_{cc}_{_{—}}_{L} to the high potential V_{ws}_{_{—}}_{H} in two horizontal periods following the second horizontal period. Specifically, in the periods of time t₁₀ to time t₁₁, the third threshold correction treatment and the fourth threshold correction treatment are respectively performed in the periods of time t₁₂ to time t₁₃.

Signal Writing and Mobility Correction Period

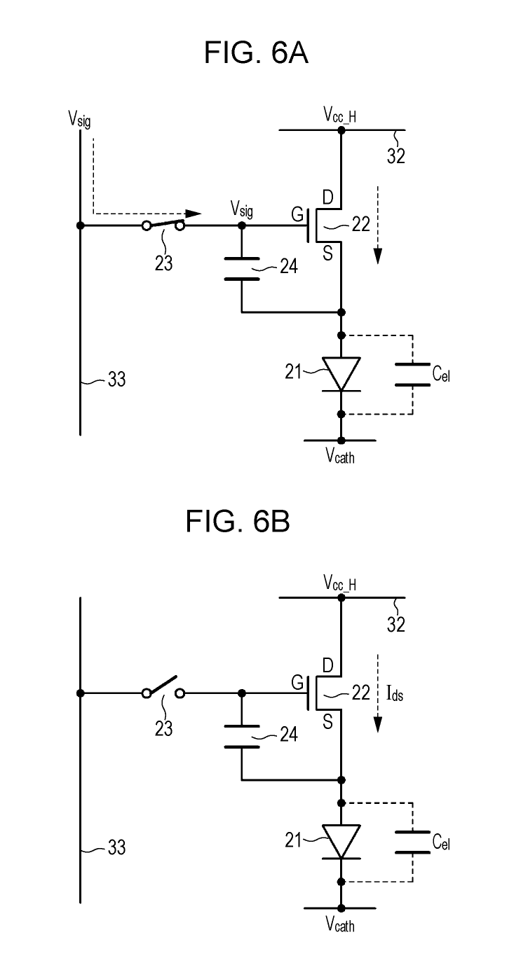

If the fourth threshold correction treatment is completed, the signal writing and mobility correction treatment is performed in the same horizontal period by switching the potential of the signal line 33 from the reference voltage V_{ofs} to the signal voltage V_{sig} of the video signal. That is, as illustrated in FIG. 6A, the sampling transistor 23 becomes conductive, samples the signal voltage V_{sig}, and writes the signal voltage V_{sig} in the pixel 20 in the period in which the signal voltage V_{sig} of the video signal is supplied to the signal line 33 at time t₁₄ by shifting the potential WS of the scanning line 31 from the low potential V_{cc}_{_{—}}_{L} to the high potential V_{ws}_{_{—}}_{H}.

The gate potential V_{g} of the driving transistor 22 becomes the signal voltage V_{sig} by writing the signal voltage V_{sig} by the sampling transistor 23. Then, when the driving transistor 22 is driven by the signal voltage V_{sig} of the video signal, finally the threshold correction treatment is performed by being offset by the voltage which corresponds to the threshold voltage Vₜₕ in which the threshold voltage Vₜₕ of the driving transistor 22 is held by the holding capacitor 24.

In addition, as illustrated in the timing waveform diagram of FIG. 3, the source potential Vₛ of the driving transistor 22 is increased over time. At this time, if the source potential Vₛ of the driving transistor 22 does not exceed the sum of the threshold voltage Vₜₕ_{_{—}}_{EL} and the cathode potential V_{cath} of the organic EL element 21, that is, if the leakage current of the organic EL element 21 is sufficiently smaller than the current flowing through the driving transistor 22, the current flowing through the driving transistor 22 flows into the holding capacitor 24 and the equivalent capacitor Cₑₗ. As a result, the charging of the holding capacitor 24 and the equivalent capacitor Cₑₗ is started.

The source potential Vₛ of the driving transistor 22 is increased over time by charging the holding capacitor 24 and the equivalent capacitor Cₑₗ. Already at this time, since the correction treatment (correction operation) of the threshold voltage Vₜₕ of the driving transistor 22 is completed, the current I_{ds} between the drain and the source of the driving transistor 22 depends on the mobility μ of the driving transistor 22. Moreover, the mobility μ of the driving transistor 22 is a mobility of a semiconductor thin film which configures the channel of the driving transistor 22.

Here, the ratio, that is, the writing gain G of the holding voltage V_{gs} of the holding capacitor 24 with respect to the signal voltage V_{sig} of the video signal is assumed to be one (ideal value). Then, the voltage V_{gs} between the gate and the source of the driving transistor 22 becomes V_{sig}−V_{ofs}+Vₜₕ−ΔV by increasing the source potential Vₛ of the driving transistor 22 to the potential of V_{ofs}−Vₜₕ+ΔV.

That is, increase ΔV of the source potential Vₛ of the driving transistor 22 acts so as to be deducted from a voltage (V_{sig}−V_{ofs}+Vₜₕ) held by the holding capacitor 24, that is, so as to charge electric charges of the holding capacitor 24. In other words, in a case of the increase ΔV of the source potential Vₛ, a negative feedback is applied to the holding capacitor 24. Accordingly, the increase ΔV of the source potential Vₛ becomes the feedback quantity of the negative feedback.

In this manner, it is possible to cancel dependency with respect to the mobility μ of the current I_{ds} between the drain and the source of the driving transistor 22 by applying the negative feedback to the voltage V_{gs} between the gate and the source in the feedback quantity ΔV which corresponds to the current I_{ds} between the drain and the source flowing through the driving transistor 22. The cancelling treatment of the dependency is the mobility correction treatment (operation) which corrects the variation of each pixel of the mobility μ of the driving transistor 22.

More specifically, since the current I_{ds} between the drain and the source is increased as signal amplitude Vᵢₙ (=V_{sig}−V_{ofs}) of the video signal which is written to the gate electrode of the driving transistor 22 is higher, an absolute value of the feedback quantity ΔV of negative feedback is also increased. Accordingly, the mobility correction treatment which corresponds to a luminance brightness level is performed.

In addition, in a case where the signal amplitude Vᵢₙ of the video signal is constant, since the absolute value of the feedback quantity ΔV of the negative feedback is also increased as the mobility μ of the driving transistor 22 is increased, it is possible to cancel the variation of the mobility μ of each pixel. Accordingly, it is possible to refer to the feedback quantity ΔV of the negative feedback as a correction amount of the mobility correction treatment.

Specifically, in the case of the driving transistor 22 with small mobility μ, the current amount at this time is large, and the increase of the source potential Vₛ is also fast. On the contrary, in the case of the driving transistor 22 with large mobility μ, the current amount at this time is small and the increase of the source potential Vₛ is also slow. As a result, since the sampling transistor 23 becomes conductive, the source potential Vₛ of the driving transistor 22 increases and becomes the voltage Vₛ₀ in which the mobility μ is reflected when the sampling transistor 23 becomes non-conductive. The voltage V_{ds} between the drain and the source of the driving transistor 22 becomes V_{sig}−Vₛ₀ and becomes the voltage which corrects the mobility μ.

Light-Emission Period

As illustrated in FIG. 6A, the sampling transistor 23 becomes non-conductive and the signal writing and mobility correction treatment are completed by shifting the potential WS of the scanning line 31 from the high potential V_{ws}_{_{—}}_{H} to the low potential V_{cc}_{_{—}}_{L} at time t₁₅. In addition, the gate electrode of the driving transistor 22 becomes a floating state by sampling transistor 23 becoming non-conductive in order to be electrically disconnected from the signal line 33.

Here, when the gate electrode of the driving transistor 22 is in the floating state, the gate potential V_{g} also changes in conjunction with the changes in the source potential Vₛ of the driving transistor 22 by connecting the holding capacitor 24 between the gate and the source of the driving transistor 22. Accordingly, the voltage V_{ds} between the drain and the source of the driving transistor 22 is kept constant.

In this manner, an operation in which the gate potential V_{g} of the driving transistor 22 changes in conjunction with the changes in the source potential Vₛ, in other words, an operation in which the gate potential V_{g} and the source potential Vₛ are increased while the voltage V_{ds} between the drain and the source held by the holding capacitor 24 is kept constant is a bootstrap operation.

The gate electrode of the driving transistor 22 becomes the floating state, and at the same time, the anode potential of the organic EL element 21 is increased according to the current I_{ds} by starting to flow the current I_{ds} between the drain and the source of the driving transistor 22 through the organic EL element 21.

Then, since the anode potential of the organic EL element 21 exceeds Vₜₕ_{_{—}}_{EL}+V_{cath}, and the driving current starts to flow through the organic EL element 21, the organic EL element 21 starts to emit the light. In addition, the increase in the anode potential of the organic EL element 21, that is, is neither more nor less than the increase in the source potential Vₛ of the driving transistor 22. Then, if the source potential Vₛ of the driving transistor 22 is increased, the gate potential V_{g} of the driving transistor 22 is also increased in conjunction with the source potential Vₛ by the bootstrap operation accompanied by the holding capacitor 24.

At this time, in a case where a bootstrap gain is assumed to be one (ideal value), the increase amount of the gate potential V_{g} of the driving transistor 22 is the increase amount of the source potential Vₛ. Therefore, the voltage V_{ds} between the gate and the source of the driving transistor 22 is constantly held in V_{sig}−V_{ofs}+Vₜₕ−ΔV during the light-emission period.

As described above, the threshold correction and the signal writing are performed during the 1H (one horizontal period) in the driving method according to the related art. Accordingly, for example, even in a case of black screen display, the reference voltage V_{ofs} and the signal voltage V_{sig} of the video signal are rewritten for each 1H to the signal line 33.

For this reason, since the number of charging and discharging in each of the signal lines 33₁ to 33ₙ is increased and total charging and discharging current is increased, the power consumption of the signal output unit 60 is increased. In other words, there is a disadvantage in that the power consumption of the signal output unit 60, and furthermore, the display device 10 accompanying the correction operation of the display unevenness due to characteristic variation of the elements configuring the pixel 20 and the like is increased in the driving method according to the related art.

In addition, if the threshold correction and the signal writing are performed during the 1H, since there is a restriction that the period which can be taken as the threshold correction period or the signal writing period has a certain relation with the one horizontal period, a case where a degree of freedom is small on setting of the correction period and the correction time is not sufficiently ensured occurs. For example, if the time of the one horizontal period is decreased by slowdown or high-speed driving, which is accompanied by the enlargement of the display panel 70, of the write-scan signal WS or the signal voltage V_{sig} of the video signal, it is difficult to sufficiently ensure the correction operation time (operation time) per operation.

For example, even if the driving method of the divided threshold correction which was previously described is used, it is difficult to successfully perform the operation of the threshold correction and to obtain excellent uniformity in a case where the time of the first threshold correction period is decreased too much.

### 3. Description with Respect to Embodiment

Therefore, in the present embodiment, one display frame period (1F) is divided into two, the threshold correction of the driving transistor 22 is performed in the first half divided period, and the signal writing is performed in the second half divided period. The mobility correction is also performed in the same period as the signal writing.

At this time, the signal output unit 60 outputs (supplies) the reference voltage V_{ofs} for the threshold correction to the signal line 33 substantially over the entire period in the first half divided period. That is, the potential of the signal line 33 is set to the reference voltage V_{ofs} substantially over the entire period of the first half divided period. In addition, the signal output unit 60 sequentially outputs (supplies) the signal voltage V_{sig} of the video signal with regard to all lines (row) in the second half divided period with respect to the signal line 33.

The operation is performed in order of threshold correction preparation→threshold correction→signal writing and mobility correction→light emission→light extinction in the same manner as a case of the driving method according to the related art. Specifically, the operation is sequentially performed in units of line in order of operation of threshold correction preparation→threshold correction in the first half divided period of 1F and is sequentially performed in units of line in order of operation of signal writing and mobility correction→light emission→light extinction in the second half divided period.

In this manner, the reference voltage V_{ofs} and the signal voltage V_{sig} may be rewritten to the signal line 33 for each 1F by dividing 1F into two, performing the threshold correction in the first half divided period, and performing the signal writing in the second half divided period. As a result, as compared to the driving method according to the related art in which the reference voltage V_{ofs} and the signal voltage V_{sig} are rewritten for each 1H, it is possible to significantly reduce the number of charging and discharging in each of the signal lines 33₁ to 33ₙ.

If a case of a raster display is exemplified, each of the charging and discharging of the signal lines 33₁ to 33ₙ is performed for each 1H in the driving method according to the related art. On the other hand, the number of each of the charging and discharging of the signal lines 33₁ to 33ₙ during the one display frame is only once in the driving method according to the present embodiment. Accordingly, the power consumption of the signal output unit 60 is close to 0 [W] as possible, and it is possible to achieve low power consumption of the signal output unit 60 and furthermore, the organic EL display device 10.

In addition, since the reference voltage V_{ofs} is typically written to the signal line 33 substantially over the entire period in the first half divided period, it is possible to relatively freely ensure long time as the threshold correction period. As a result, for example, when the time of the one horizontal period is decreased by slowdown or high-speed driving, which is accompanied by the enlargement of the display panel 70, of the write-scan signal WS or the signal voltage V_{sig} of the video signal, the lack of the operation time, which is a concern in the driving method according to the related art, is not caused. As a result, since it is possible to achieve prolongment of the threshold correction time per operation only by the change of the driving time without the change of the circuit configuration, it is possible to obtain excellent uniformity by the operation of the sufficient threshold correction.

Hereinafter, description will be given with reference examples and examples of the driving method according to the present embodiment.

### 3-1. Reference Examples

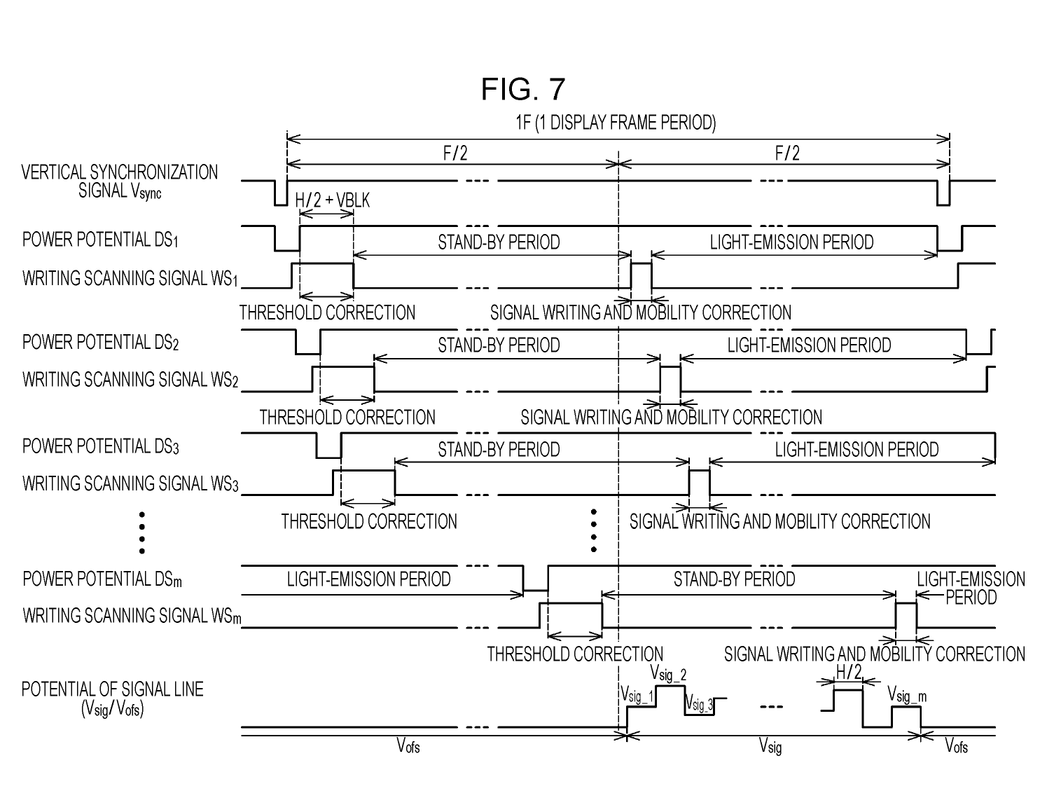

FIG. 7 is a timing waveform diagram with regard to the driving method according to the reference example. In the driving method of the reference example, the signal writing is performed in the divided period of F/2 of the second half by equally dividing the one display frame period (1F) into two by F/2, and performing the threshold correction in the divided period of F/2 of the first half.

The reference voltage V_{ofs} is output from the signal output unit 60 33 substantially over the entire period in the divided period of F/2 of the first half, and the signal voltage V_{sig} with regard to all lines (row) is sequentially output to the signal line in the divided period of F/2 of the second half. Then, the operation is performed in order of threshold correction preparation→threshold correction→signal writing and mobility correction→light emission→light extinction in the same manner as a case of the driving method according to the related art.

Specifically, the operation is sequentially performed in units of line in order of operation of threshold correction preparation→threshold correction in the divided period of F/2 of the first half. That is, the operation of the threshold correction preparation is performed in a period from the timing when the potential (power potential) DS of the power supply line 32 is shifted from the high potential side to the low potential side until the timing when the potential is shifted again from the low potential side to the high potential side. Subsequently, the operation of the threshold correction preparation is performed in a period from the timing when the power potential DS is shifted from the low potential side to the high potential side until the timing when the write-scan signal WS is shifted from the high potential side to the low potential side.

In addition, the operation is sequentially performed in units of line in order of operation of signal writing and mobility correction→light emission→light extinction in the divided period of F/2 of the second half. That is, the power potential DS becomes a high potential state, and the operation of the signal writing and mobility correction is performed in the period when the write-scan signal WS is in the high potential state (active state). In the timing waveform diagram of FIG. 7, V_{sig}_{_{—}}₁ to V_{sig}_{_{—}}ₘ are the signal voltages of the video signals in the first line (row) to the mth line and are sequentially supplied from the signal output unit 60 to the signal lines 33₁ to 33ₙ in a cycle of H/2.

In a case where the one display frame period (1F) is equally divided into two by F/2, since only the reference voltage V_{ofs} is output to the signal line 33 in the divided period of F/2 of the first half, the one display frame period is in standby for one line during approximately ½ frame period from the threshold correction to the signal writing and mobility correction.

In this manner, since the reference voltage V_{ofs} is output to the signal line 33 substantially over the entire period of the divided period of F/2 of the first half by the driving method according to the reference example in which the one display frame period is equally divided into two by F/2, it is possible to relatively freely ensure the threshold correction time in the divided period of F/2.

Specifically, it is possible to use H/2 period+vertical blanking (VBLK) period as the threshold correction period. That is, it is possible to ensure extra correction time by the amount of vertical blanking (VBLK) period with respect to the threshold correction time per operation of the driving method according to the related art, in which the threshold correction and the signal writing are performed during the 1H period.

As a result, since it is possible to achieve prolongment of the threshold correction time per operation only by the change of the driving time without the change of the circuit configuration, it is possible to obtain uniformity which is more excellent that the operation of the sufficient threshold correction. Incidentally, the operation is performed on the signal writing and mobility correction in the H/2 period in the same manner as the driving method according to the related art.

In addition, it is possible to make time of the standby period from the threshold correction operation to the signal writing and mobility correction operation constant according to the driving method according to the reference example. As a result, since the minute leakage current, which occurs in the standby period, of the driving transistor 22 is constant for each line, it is possible to suppress occurrence of vertical shading.

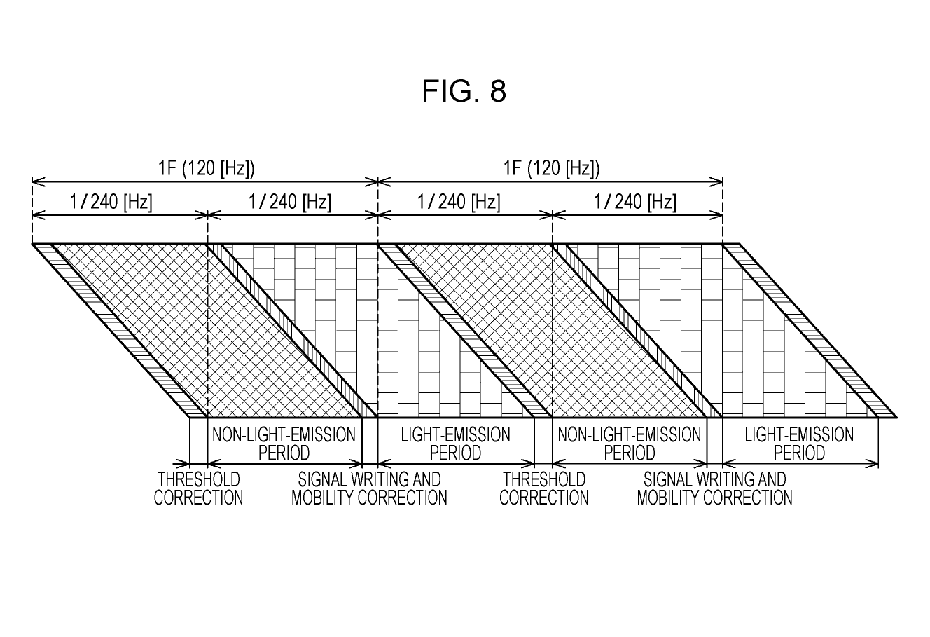

FIG. 8 is a conceptual diagram with regard to the threshold correction, the signal writing, and the mobility correction in a case of the driving method according to the reference example.

In a case where the one display frame period is equally divided into two, since it is necessary to respectively scan the one display frame period by once in the first and second halves of the one display frame, scanning speed of the threshold correction and the signal writing and mobility correction becomes twice as fast as a case where the one display frame period is not divided into two.

As an example, in a case where resolution is Full HD (1920×1080) by driving the one display frame at 120 [Hz], the scanning speed of the driving method according to the related art in which the one display frame period is not divided into two is 1/120/1080=7.7 [μsec]. On the other hand, in a case of the driving method according to the reference example, the scanning speed is 1/240/1080=3.8 [μsec] and is twice as fast as the driving method according to the related art.

As is apparent from this, although it is possible to relatively freely ensure the threshold correction time in the driving method according to the reference example, since the scanning speed becomes twice as fast as the driving method according to the related art and the mobility correction time is decreased with respect to the signal writing and mobility correction, there is a concern that the lack of the correction of the mobility μ occurs. The method which is made in view of this point is the driving method according to the example to be described below.

### 3-2. Example

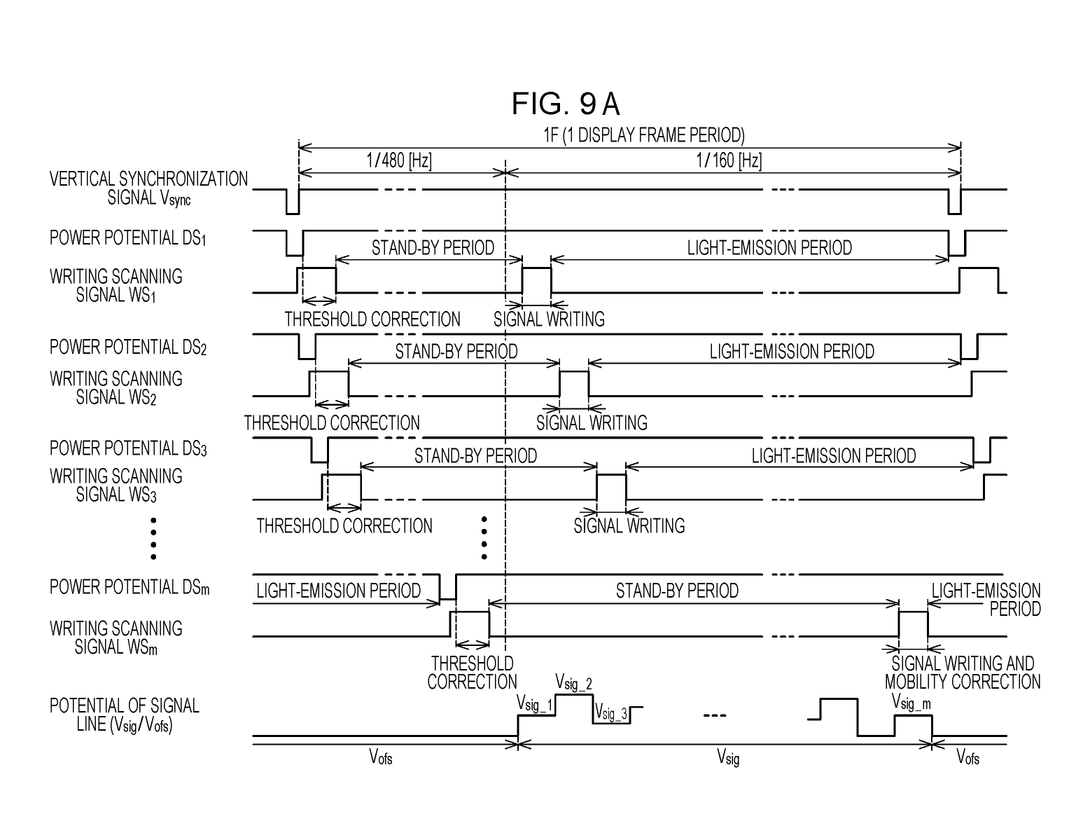

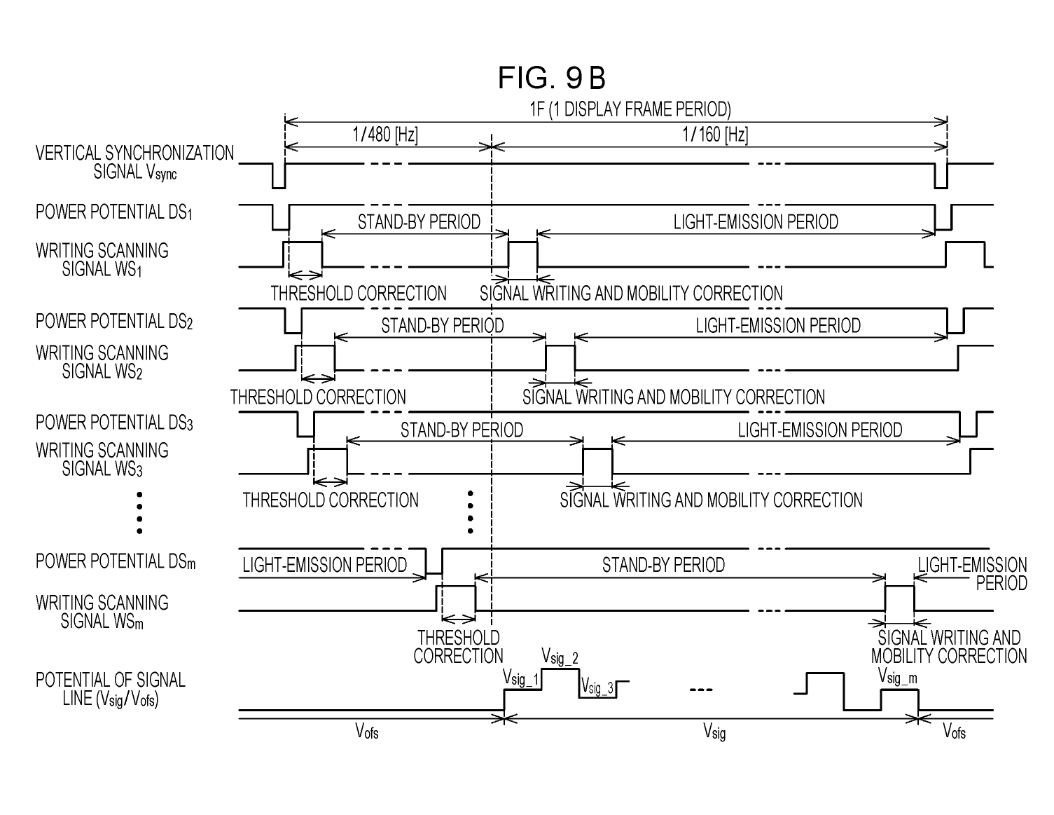

FIG. 9A is a timing waveform diagram with regard to the driving method according to an example.

In the driving method according to the example, the second half divided period is set to be longer than the first half divided period when the one display frame period (1F) is divided into two, the threshold correction is performed in the first half divided period, and the signal writing is performed in the second half divided period. Such a setting enables the scanning speed with regard to the signal writing to be slower than the driving method according to the reference example in which 1F is equally divided into two.

As an example, in a case where the one display frame is driven at 120 [Hz] and the resolution is Full HD, driving frequency of the threshold correction in the first half divided period is set to 480 [Hz], which is twice as fast, from 240 [Hz] of the driving method according to the reference example and the driving frequency of the signal writing is set to 160 [Hz] from 240 [Hz].

If the driving frequency of the signal writing becomes 160 [Hz], the scanning speed becomes 1/160/1080=5.78 [μsec]. That is, it is possible to ensure a time margin of approximately 2 [μsec] with respect to scanning speed 3.8 [μsec] when the driving method according to the reference example is 240 [Hz] with respect to the scanning speed with regard to the signal writing.

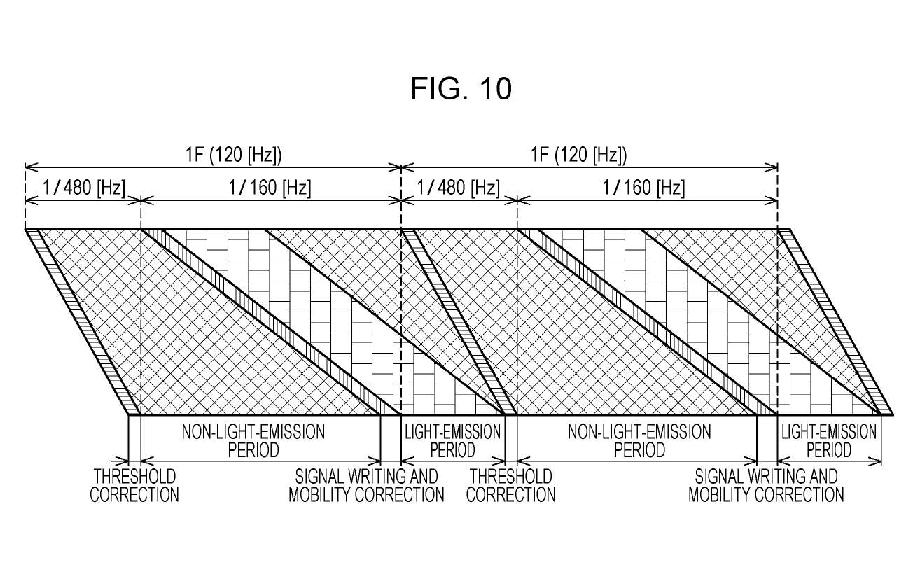

FIG. 9B is a timing waveform diagram with regard to the driving method according to an example. In addition, FIG. 10 is a conceptual diagram with regard to the threshold correction, the signal writing, and the mobility correction in a case of the driving method according to the example.

In the driving method according to the example, the second half divided period is set to be longer than the first half divided period when the one display frame period (1F) is divided into two, the threshold correction is performed in the first half divided period, and the signal writing is performed in the second half divided period. Such a setting enables the scanning speed with regard to the signal writing and mobility correction to be slower than the driving method according to the reference example in which 1F is equally divided into two.

As an example, in a case where the one display frame is driven at 120 [Hz] and the resolution is Full HD, driving frequency of the threshold correction in the first half divided period is set to 480 [Hz], which is twice as fast, from 240 [Hz] of the driving method according to the reference example and the driving frequency of the signal writing and mobility correction is set to 160 [Hz] from 240 [Hz].

If the driving frequency of the signal writing and mobility correction becomes 160 [Hz], the scanning speed becomes 1/160/1080=5.78 [μsec]. That is, it is possible to ensure a time margin of approximately 2 [μsec] with respect to scanning speed 3.8 [μsec] when the driving method according to the reference example is 240 [Hz] with respect to the scanning speed with regard to the signal writing and mobility correction.

In this manner, it is possible to ensure the margin of the operation time of the mobility correction by setting the second half divided period to be longer than the first half divided period and setting the scanning speed with regard to the signal writing and mobility correction to be slower than the scanning speed with regard to the threshold correction. As a result, since it is possible to more reliably perform the mobility correction, it is possible to obtain a display screen with high uniformity.

In addition, also with respect to the threshold correction, since it is possible to achieve the prolongment of the threshold correction time per operation, it is possible to obtain the excellent uniformity by the operation of the sufficient threshold correction as compared to the driving method according to the related art in which the threshold correction and the mobility correction are performed during the 1H period.

### 4. Modified Example

Hereinafter, description is given with regard to the technology of the present disclosure; however the technology according to the embodiment of the present disclosure is not limited to the above-described embodiments. That is, various modifications or improvements may be added to the above-described embodiments within a range that does not depart from the concept of the technology according to the embodiment of the present disclosure, and the embodiments to which such modifications or improvements are added also included in the technical range of the technology of the present disclosure.

For example, in the above-described embodiments, a 2Tr/1C-type circuit which is configured to have two transistors (22 and 23) and one capacitor element (24) is used as the driving circuit which drives the organic EL element 21, but the driving circuit is not limited thereto. If necessary, it is also possible to use a 2Tr/2C-type circuit to which an auxiliary capacitor connecting one electrode to the anode of the organic EL element 21 and connecting the other electrode to the fixed potential is added in order to supplement a capacitor shortage of the organic EL element 21 and to increase the writing gain of the video signal with respect to the holding capacitor 24, if necessary.

In addition, it is also possible to use a 3Tr/1C (2C)-type circuit to which a switching transistor which selectively gives the reference voltage V_{ofs} used in the threshold correction to the driving transistor 23 is added, or if necessary, to use a circuit to which one or a plurality of transistor are further added.

Furthermore, in the above-described embodiment, description was given by exemplifying a case where the organic EL display device to which the organic EL element is used as the electro-optical element of the pixel 20 is applied, but the present disclosure is not limited to the application. Specifically, the present disclosure is applicable to general display devices which use the current-driven electro-optical element in which the luminance brightness is changed according to the current value flowing through a device such as an inorganic EL element, an LED element, a semiconductor laser element, and the like.

### 5. Electronic Apparatus

It is possible that the above-described display device according to the embodiment of the present disclosure uses an video signal which is input to an electronic apparatus or a video signal which is created in the electronic apparatus as a display unit (display device) thereof in the electronic apparatus in all fields to be displayed as a video or an image.

According to the description of the above-described embodiment, it is possible that the display device according to the embodiment of the present disclosure obtains the display screen with high uniformity while achieving a decrease in power consumption accompanied by the correction operation of the display unevenness due to variations in the characteristics of the element which configures the pixels. Accordingly, it is possible to contribute to the low power consumption of the electronic apparatus and to obtain a display screen with excellent image quality in the electronic apparatus in all fields by using the display device according to the embodiment of the present disclosure as the display unit.

It is possible to exemplify, for example, a digital camera, a video camera, a game console, and a notebook computer, and the like in addition to a television system as the electronic apparatus which uses the display device according to the embodiment of the present disclosure as the display unit. In addition, it is possible to use the display device according to the embodiment of the present disclosure as the display unit in the electronic apparatus such as a portable information device such as an e-book device or an electronic watch or the like, a mobile communication device such as a mobile phone or a PDA or the like.

### 6. Configuration of the Present Disclosure

Moreover, it is possible that the present disclosure adopts the following configuration.

The driving method of the display device comprises providing a display frame period consisting of a first period and a second period, a duration of the second period being longer than the first period and being set as the first period subtracted from the display frame period; performing a threshold correction for the driving transistor during the first period; and writing a signal voltage for the pixel during the second period.

In one embodiment, a length of the first period is shorter than or equal to a length of the display frame period. In another embodiment, the length of the first period is shorter than or equal to a quarter of the length of the display frame period.

The driving method of the display device further includes setting a driving frequency for the performing the threshold correction as being faster than the driving frequency for the writing the signal voltage and setting a scanning speed for the performing the threshold correction as being faster than the scanning speed for the writing the signal. Additionally, the driving method of the display device includes correcting mobility of the driving transistor during the second period.

The display device further includes a sampling transistor and the driving method of the display device includes sampling a reference voltage during the first period and sampling the signal voltage during the second period.

It is further possible that the present disclosure adopts the following configuration.

[1] A display device includes a sampling transistor which samples a signal voltage of a video signal, a holding capacitor which holds the signal voltage sampled by the sampling transistor, a pixel array unit that is formed by disposing a pixel circuit which has a driving transistor which drives a light-emitting unit according to the signal voltage which is held by the holding capacitor, and a drive unit which drives the pixel circuit such that threshold correction of the driving transistor in a first half divided period which is obtained by dividing one display frame period into two is performed and writing of the signal voltage in a second half divided period which is set to be longer than the first half divided period.

[2] The display device according to [1], in which mobility correction of the driving transistor is performed in the second half divided period.

[3] The display device according to [1] or [2], in which the holding capacitor is connected between a gate electrode and one of source/drain electrodes of the driving transistor.

[4] The display device according to any one of [1] to [3], in which the sampling transistor which samples a reference voltage which is supplied to a signal line at timing different from the signal voltage of video signals which is used for the threshold correction.

[5] The display device according to any one of [1] to [4], in which the drive unit performs the threshold correction by changing the a potential of one of source/drain electrodes of the driving transistor to be the potential in which a threshold voltage of the driving transistor is decreased from an initialization potential based on the initialization potential of the gate potential of the driving transistor.

[6] The display device according to [5], in which the reference voltage which is used to determine the initialization potential with respect to the signal line is supplied in the first half divided period.

[7] The display device according to any one of [2] to [6], in which the drive unit performs mobility correction by applying a negative feedback with respect to the holding capacitor with a feedback quantity which corresponds to the current flowing through the driving transistor in the period during which the signal voltage is written by the sampling transistor.

[8] The display device according to [7], in which the signal voltage of the video signal is supplied to the signal line in the second half divided period.

[9] A display device, in which a pixel circuit that has a sampling transistor which samples a signal voltage of a video signal, a holding capacitor which holds the signal voltage sampled by the sampling transistor, and a driving transistor which drives a light-emitting unit according to the signal voltage which is held by the holding capacitor is disposed, and in which a sampling transistor performs sampling of the signal voltage in a first half divided period in which one display frame period is divided into display two periods and performs sampling of a signal voltage in a second half divided period which is set to be longer than the first half divided period.

[10] The display device according to [9], in which the threshold correction of the driving transistor is performed in the first half divided period.

[11] The display device according to [9], in which the writing of the signal voltage is performed in the second half divided period.

[12] The display device according to [11], in which the mobility correction of the driving transistor is further performed in the second half divided period.

[13] A driving method of a display device includes, in which when a display device that is formed by disposing a pixel circuit which has a sampling transistor which samples a signal voltage of a video signal, a holding capacitor which holds the signal voltage sampled by the sampling transistor, and a driving transistor which drives a light-emitting unit according to the signal voltage which is held by the holding capacitor is driven, performing a threshold correction of a driving transistor in a first half divided period in which one display frame period is divided two periods, and performing writing of a signal voltage in a second half divided period which is set to be longer than the first half divided period.

[14] An electronic apparatus includes, a pixel array unit on that is formed by disposing a pixel circuit which has a sampling transistor which samples a signal voltage of a video signal, a holding capacitor which holds the signal voltage sampled by the sampling transistor, and a driving transistor which drives a light-emitting unit according to the signal voltage which is held by the holding capacitor, and a display device which performs a threshold correction of a driving transistor in a first half divided period in which one display frame period is divided two periods and drive unit includes a drive unit which drives a pixel circuit for performing writing of a signal voltage in a second half divided period which is set to be longer than the first half divided period.

It should be understood by those skilled in the art that various modifications, combinations, sub-combinations and alterations may occur depending on design requirements and other factors insofar as they are within the scope of the appended claims or the equivalents thereof.

What is claimed is:

1. A driving method of a display device including a pixel having a driving transistor, comprising:
providing a display frame period consisting of a first period and a second period, a duration of the second period being longer than the first period and being set as the first period subtracted from the display frame period;
performing a threshold correction for the driving transistor during the first period; and
writing a signal voltage for the pixel during the second period

2. The driving method according to claim 1, further comprising:
setting a driving frequency for the performing the threshold correction as being faster than the driving frequency for the writing the signal voltage.

3. The driving method according to claim 1, further comprising:
setting a scanning speed for the performing the threshold correction as being faster than the scanning speed for the writing the signal.

4. The driving method according to claim 1, further comprising:
correcting mobility of the driving transistor during the second period.

5. The driving method according to claim 1, wherein the pixel further includes a sampling transistor.

6. The driving method according to claim 5, further including sampling, by the sampling transistor, a reference voltage during the first period.

7. The driving method according to claim 5, further including sampling, by the sampling transistor, the signal voltage during the second period.

8. The driving method according to claim 1, wherein a length of the first period is shorter than or equal to a length of the display frame period.

9. The driving method according to claim 8, wherein the length of the first period is shorter than or equal to a quarter of the length of the display frame period.

10. A display device comprising:
a plurality of pixel circuits, a scan line, a signal line, at least one of the plurality of pixel circuits including a driving transistor,
wherein a display frame period has a first period and a second period, a length of the first period being shorter than a length of the second period and being set as the first period subtracted from the display frame period; and wherein a threshold correction for the driving transistor is performed during the first period, and a signal voltage writing to one of the plurality of pixel circuits via the signal line is performed during the second period.

11. The display device according to claim 10, wherein a driving frequency for the threshold correction is faster than the driving frequency for the signal voltage writing.

12. The display device according to claim 10, wherein a scanning speed for the threshold correction is faster than the scanning speed for the signal voltage writing.

13. The display device according to claim 10, wherein a mobility correction is performed during the second period.

14. The display device according to claim 10, wherein the at least one of the plurality of pixel circuits further includes a sampling transistor.

15. The display device according to claim 14, wherein the sampling transistor samples a reference voltage during the first period.

16. The display device according to claim 14, wherein the sampling transistor samples the signal voltage during the second period.

17. The display device according to claim 10, wherein the length of the first period is less than or equal to a length of the display frame period.

18. The display device according to claim 10, wherein the length of the first period is less than or equal to a quarter of the length of the display frame period.

19. An electronic apparatus having a display device comprising:
a plurality of pixel circuits, a scan line, a signal line, at least one of the plurality of pixel circuits including a driving transistor,
wherein a display frame period has a first period and a second period, a duration of the second period being longer than the first period and being set as the first period subtracted from the display frame period; and wherein a threshold correction for the driving transistor is performed during the first period, and a signal voltage writing to one of the plurality of pixel circuits via the signal line is performed during the second period.

20. The electronic apparatus according to claim 19, wherein a driving frequency for the threshold correction is faster than the driving frequency for the signal voltage writing.

21. The electronic apparatus according to claim 19, wherein a scanning speed for the threshold correction is faster than the scanning speed for the signal voltage writing.
